(19) United States
(12) Patent Application Publication
(10) Pub. No.: US 2007/0292562 A1
(43) Pub. Date: Dec. 20, 2007

(54) Aqueous Stabilization of Liquid Dough Conditioning Composition

(76) Inventors: Matthew Green, Buckinghamshire (GB); Robert Whitehurst, Northampton (GB)

Correspondence Address: Baker & Hostetler;Suite 1100, Washington Square, 1050 Connecticut Avenue N W, Washington, DC, 20036, US

(21) Appl. No.: 10/558,983

(22) PCT Filed: Jun. 2, 2004
(86) PCT No.: PCT/GB04/02323

§ 371 Date: Jan. 8, 2007

(30) Foreign Application Priority Data
Jun. 2, 2003 (GB) 0312606.7

(51) Int. Cl. A21D 10/00; A21D 13/00; A21D 2/06; A21D 2/18; A21D 2/22; A21D 8/04

(52) U.S. Cl. 426/20; 426/61; 426/62

(57) ABSTRACT

The present invention relates to a liquid composition and, more particularly, to a dough conditioner, comprising one or more enzymes, an oxidant such as ascorbic acid and a water soluble antioxidant such as sodium metabisulphite. The invention also relates to a process for preparing said liquid composition as well as to a process for the preparation of a product baked with such a composition.

The present invention relates to liquid compositions for performing a stabilizing function and a dough conditioning function, and to a process for the preparation of a dough using said improving compositions and also to a process for the preparation of a baked product using such a dough.

It will be well understood by a person skilled in the art that the dough conditioners (i.e. bread improvers) typically used in the preparation of baked dough products are generally provided in a dry form (e.g. powder or tablet form) or as an emulsifier based liquid composition comprising a lipid carrier. A problem associated with both these forms of dough conditioner is that they are relatively difficult to pump and dose which, in turn, complicates their use in the mass production of dough and baked dough products. Furthermore, dry forms of dough conditioner can result in a dusting effect which can cause allergic reactions. Also, oil based conditioners undesirably increase the fat content of a product and, additionally, the emulsifier content tends to thicken the fluid, cause instability at temperatures above 35° C., and result in excessive viscosity at temperatures below 10° C.

Aqueous compositions are perhaps a preferred form of dough conditioner inasmuch as their carrier (water) is inexpensive, low fat and results in a non-dusting product. Aqueous solutions of dough conditioner may also be readily pumped and dosed allowing for a convenient mass production of dough products. However, aqueous solutions or suspensions of a dough conditioner are unstable due to denaturation/decomposition of the ascorbic acid (used as an oxidant) and enzyme systems used as the active ingredients. This instability also tends to increase with ambient temperature. Due to minimum shelf life requirements, use of aqueous compositions of dough conditioners has not in the past been practical. Nevertheless, in WO 02/26044 A2, a liquid bread improving composition comprising one or more polyols in an aqueous solution is disclosed. The polyols lower water activity to such an extent that the processes which inactivate enzymes and degrade ascorbic acid and microbial infections are slowed. As a result, the shelf life of the composition is increased.

It is an object of the present invention to provide improved aqueous compositions of dough conditioners, and associated products, and a process for preparing the same.

A first aspect of the present invention provides a liquid composition comprising one or more enzymes, an oxidant and a water soluble antioxidant. Ideally, the water soluble antioxidant is sulphur dioxide or sulphur dioxide generating. Preferably the water soluble antioxidant is sodium metabisulphite. The composition may be characterised by a sodium metabisulphite content of up to 1.0 wt %. Furthermore, the composition may be characterised by a sodium metabisulphite content of approximately 0.1 wt %.

Also, the composition may ideally comprise a water soluble alkali, preferably sodium hydroxide. The composition may also comprise a hydrocolloid, an emulsifier (e.g. sodium stearoyl lactylate), a polysaccharide (e.g. starch), or other means for increasing the viscosity of the composition. The emulsifier should be of a food grade. The hydrocolloid may be Xanthan gum. Said one or more enzymes may comprise lipase and said oxidant (i.e. oxidising agent) is ideally ascorbic acid.

A second aspect of the present invention provides a process for preparing the aforementioned liquid composition, wherein the water soluble antioxidant is added to water before the oxidant is added to said water. The water ideally comprises dissolved sugar and/or dissolved salt (which is preferably added to the water before the addition of said antioxidant). After said water soluble antioxidant is added (and preferably after the oxidant is added), it is preferable for a water soluble alkali, ideally sodium hydroxide solution, to be added. The alkali may be added so as to increase pH to approximately 3.0 to 8.0, preferably 4.0 to 5.0, and more preferably to 4.5. Preferably, after said alkali is added, one or more enzymes are added. Also, after said one or more enzymes are added, it is preferable for a hydrocolloid to be added. The oxidant may be ascorbic acid.

A third aspect of the present invention relates to use of a water soluble antioxidant to stabilise a liquid dough conditioning composition comprising one or more enzymes and ascorbic acid.

A fourth aspect of the present invention provides a dough prepared by mixing flour, yeast, water and an effective quantity of any of the aforementioned compositions.

A fifth aspect of the present invention provides a process for preparing a dough comprising mixing flour, yeast, water and an effective quantity of any of the aforementioned compositions. This process ideally comprises the step of separately adding a fluidised emulsifier (ideally as specifically mentioned herein) to said mix of flour, yeast, water and quantity of composition.

A sixth aspect of the present invention provides a baked product prepared by baking the aforementioned dough according to the fourth aspect of the present invention or prepared by the aforementioned process according to the fifth aspect of the present invention.

A seventh aspect of the present invention relates to use of the aforementioned liquid composition, according to the first aspect of the present invention, for the preparation of a dough and any product baked therefrom.

A further aspect of the present invention relates to use of the aforementioned liquid composition, according to the first aspect of the present invention, as a microbial stabilizing agent.

An embodiment of the present invention will now be described.

A 0.25% aqueous solution of dough conditioner may be prepared in accordance with the present invention by first adding sugar, salt and sodium metabisulphite to water. As an alternative to sodium metabisulphite, one of the following may be used: sulphur dioxide, sodium sulphite, sodium hydrogen sulphite, potassium metabisulphite, calcium sulphite and calcium hydrogen sulphite. When selecting the antioxidant, regard should of course be had to local legislation on food additives. The sugar, salt and sodium metabisulphite are dissolved in the water by stirring. The sugar and salt may each be added in the quantity of 10-40 wt %. However, in trials, a solution has been used with 23 wt % sugar, 20 wt % salt and 57 wt % water. Alternatively, either the salt or the sugar may be omitted. In this case, where just salt is used, a quantity of 30-35 wt % is preferable, with 36 wt % as the ideal. However, where sugar alone is used, the preferred quantity is 40-70 wt %, with 60 wt % as the ideal. The sodium metabisulphite is added in a quantity of approximately 0.1 wt % (of the final liquid composition ready for use).

Once the sodium metabisulphite has been dissolved in the solution, the ascorbic acid may then be added and dissolved with stirring. It is important that the sodium metabisulphite is added prior to the ascorbic acid being added so as to ensure that the sodium metabisulphite can have an oxygen scavenging effect on the water and thereby reduce degradation of the ascorbic acid. The pH of the sodium metabisulphite and ascorbic acid solution will be approximately 1.0 to 3.0. This value should be verified as necessary using a calibrated pH meter. The pH of the solution is then adjusted to the value of 3.0 to 8.0 (preferably 4.0 to 5.0 and more preferably 4.5) by adding sodium hydroxide solution (or any other suitable food grade water soluble alkali). The required enzymes are then added and thoroughly stirred into the solution. Suitable enzymes will be apparent to the skilled reader. It is, however, particularly desirable to use one or more enzymes selected from a group consisting of lipase, lipoxygenase, amylase, hemicellulase, maltogenic amylase, phospholipase, beta-glucanase, amyloglucosidase, glucose oxidase, hexose oxidase, laccase and transglutaminase. The enzymes lipase and phospholipase have particular efficacy in relation to the present invention. A hydrocolloid (for example, Xanthan gum) is then added and the solution is stirred until a smooth gel is formed. The solution is ideally mixed with a high shear mixer.

The resultant aqueous fluid may then be stored at or below room temperature for later use as a dough conditioner (bread improving composition). Indeed, in tests of the composition, it was found that bread baked with dough comprising a six month old sample of composition was within acceptable parameters. More specifically, bread was baked from a dough mixed with directly added ascorbic acid and enzymes (the control mixture) and from a dough mixed with the 0.25 wt % dough conditioner aqueous fluid (the test mixture). This was repeated periodically as the aqueous fluid aged at room temperature over a six month period. The ingredients for the control and test mixtures are as follows:

| | Weight/g | Weight/g |
|---|---|---|
| Ingredient | Control Mixture | Test Mixture |
| Wheat flour | 3000 | 3000 |
| Salt | 60 | 60 |
| Yeast | 75 | 75 |
| Soya flour | 30 | 30 |
| Water | 1890 | 1890 |
| Aqueous fluid | — | 7.5 |
| Ascorbic acid | 0.3831 | — |
| Enzymes | 0.66 | — |
| Aqueous carrier | 7.5 | — |

The dough was mixed in a high speed mixer using 11 watt hrs/kg.
The mixer was operated using a vacuum with a 60 second delay.
The dough was proved to 10 mm from the top of the bread tin.
The bread was baked @500° F. for approximately 25 minutes.

Bread was first baked from the control and text mixtures on the day following preparation of the test mixture. No significant differences between the bread of the control mixture and the bread of the test mixture were found. When bread was prepared from dough comprising approximately six month old aqueous fluid, bread quality was found acceptable when compared to bread baked from a fresh control mixture.

It will be understood by the skilled person that the sugar and salt in the aqueous fluid serves to protect the enzymes and preserve microbiologically the entire solution. It will also be understood that there is a tendency for the ascorbic acid to oxidise with oxygen in the water and this causes an undesirable degrading of the ascorbic acid. In order to reduce this degradation, a water soluble food grade antioxidant is initially added (preferably sulphur dioxide or an antioxidant which produces sulphur dioxide such as sodium metabisulphite) to perform as an oxygen scavenger. The sodium hydroxide solution (or other food grade alkali solution) is added with the purpose of adjusting the pH value and thereby enhancing the stability of the enzyme carrying solution. The necessary dough improving enzymes are then added, followed by a hydrocolloid to thicken the solution, act as a suspending agent and further reduce water activity.

The liquid composition described above as a dough conditioner may be used in an alternative application to hinder growth of bacteria in compositions. In other words, said liquid composition may also be used as a microbial stabilizing agent. The liquid composition may also be used in a further alternative application to resist freezing. It has been found that, surprisingly, composition kept at −18° C. does not freeze and maintains its performance. It has also been a surprise to find that said liquid composition is stable and does not separate at temperatures above 45° C.

The present invention is not limited to the specific embodiment described above. Alternative arrangements will be apparent to a reader skilled in the art. For example, although ascorbic acid is widely used in dough conditioners and takes the role of an oxidant, other oxidants may be used where food additive legislation permits (for example, in the US). Alternatives to ascorbic acid include potassium bromate, potassium iodate, calcium peroxide, and azodicarbonamide. Also, where food additive legislation permits, alternative antioxidants to those indicated above may be used, for example, L-cysteine hydrochloride.

1-34. (canceled)

35. A liquid dough conditioning composition, comprising one or more enzymes, an oxidant and a water soluble antioxidant; further comprising salt in a quantity of between 30 wt % and 36 wt %.

36. The composition as claimed in claim 35, wherein the salt content is 36 wt %.

37. A liquid dough conditioning composition, comprising one or more enzymes, an oxidant and a water soluble antioxidant; further comprising sugar in a quantity of between 40 wt % and 70 wt %.

38. The composition as claimed in claim 37, wherein the sugar content is 60 wt %.

39. A liquid dough composition comprising one or more enzymes, an oxidant and a water soluble antioxidant; further comprising sugar in a quantity of between 10 wt % and 40 wt % and salt in a quantity of between 10 wt % and 40 wt %.

40. The composition as claimed in claim 37, wherein the sugar content is 23 wt % and a salt content of 20 wt %.

41. The composition as claimed in claim 35, wherein the water soluble antioxidant is sulphur dioxide or sulphur dioxide generating.

42. The composition as claimed in claim 35, wherein the water soluble antioxidant is sodium metabisulphite.

43. The composition as claimed in claim 42, wherein the sodium metabisulphite content is up to 1.0 wt %.

44. The composition as claimed in claim 43, wherein the sodium metabisulphite content is approximately 0.1 wt %.

45. The composition as claimed in claim 35, further comprising a water soluble alkali.

46. The composition as claimed in claim 45, wherein the water soluble alkali is sodium hydroxide.

47. The composition as claimed in claim 35, further comprising soluble means for increasing the viscosity of said composition.

48. The composition as claimed in claim 47, wherein said viscosity increasing means comprises an emulsifier.

49. The composition as claimed in claim 48, wherein said emulsifier is sodium stearoyl lactylate.

50. The composition as claimed in claim 47, wherein said viscosity increasing means comprises a polysaccharide.

51. The composition as claimed in claim 50, wherein said polysaccharide is starch.

52. The composition as claimed in claim 47, wherein said viscosity increasing means comprises a hydrocolloid.

53. The composition as claimed in claim 52, wherein the hydrocolloid is Xanthan gum.

54. The composition as claimed in claim 39, wherein said one or more enzymes comprises lipase.

55. The composition as claimed in claim 39, wherein said oxidant is ascorbic acid.

56. A process for preparing a liquid dough conditioning composition comprising one or more enzymes, an oxidant and a water soluble antioxidant, wherein the water soluble antioxidant is added to water before the oxidant is added to said water.

57. The process as claimed in claim 56, wherein said water comprises dissolved sugar.

58. The process as claimed in claim 56, wherein said water comprises dissolved salt.

59. The process as claimed in claim 56, wherein the salt is added to said water in a quantity of between 30 wt % and 36 wt %.

60. The process as claimed in claim 59, wherein the salt is added to said water in a quantity of 35 wt %.

61. The process as claimed in claim 56, further comprising adding sugar to said water in a quantity of 23 wt % and a salt content of 20 wt %.

62. The process as claimed in claim 56, further comprising adding sugar to said water in a quantity of between 40 wt % and 70 wt %.

63. The process as claimed in claim 62, further comprising adding sugar to said water in a quantity of 60 wt %.

64. The process as claimed in claim 56, wherein, after said water soluble antioxidant is added, a water soluble alkali is added.

65. The process as claimed in claim 64, wherein said alkali is added after said oxidant is added.

66. The process as claimed in claim 64, wherein said water soluble alkali is added so as to adjust pH to approximately 3.0 to 8.0, preferably 4.0 to 5.0, and more preferably to 4.5.

67. The process as claimed in claim 64, wherein said water soluble alkali is sodium hydroxide.

68. The process as claimed in claim 64, wherein, after said water soluble alkali is added, one or more enzymes are added.

69. The process as claimed in claim 68, wherein, after said one or more enzymes are added, a hydrocolloid is added.

70. The process as claimed in claim 56, wherein said oxidant is ascorbic acid.

71. Use of a water soluble antioxidant to stabilize a liquid dough conditioning composition comprising one or more enzymes and ascorbic acid.

72. A dough prepared by mixing flour, yeast, water and an effective quantity of composition as claimed in claim 35.

73. A process for preparing a dough comprising mixing flour, yeast, water and an effective quantity of composition as claimed in claim 35.

74. The process as claimed in claim 39, comprising the step of adding a fluidized emulsifier to said mix of flour, yeast, water and quantity of composition.

75. A baked product prepared by baking a dough according to claim 72.

76. A baked product prepared by a process according to claim 39.

77. A baked product prepared by a process according to claim 40.

78. Use of a liquid composition as claimed in claim 35, further comprising the preparation of a dough and any product baked therefrom.

79. A liquid dough conditioning composition comprising a liquid composition as claimed in claim 35.

80. (canceled)

81. (canceled)
